(19) United States
(12) Patent Application Publication
(10) Pub. No.: US 2022/0073728 A1
(43) Pub. Date: Mar. 10, 2022

(54) FOAM

(71) Applicant: DSM IP Assets B.V., Heerlen (NL)

(72) Inventors: Peter ROOZEMOND, Echt (NL); Nancy EISENMENGER, Echt (NL); Tom Antonius Philomena ENGELS, Echt (NL)

(21) Appl. No.: 17/417,027

(22) PCT Filed: Dec. 19, 2019
(86) PCT No.: PCT/EP2019/086337

§ 371 Date: Jun. 21, 2021

(30) Foreign Application Priority Data
Dec. 22, 2018 (EP) 18215814.7
Mar. 18, 2019 (EP) 19163567.1
Jul. 1, 2019 (EP) 19183676.6

(51) Int. Cl. C08L 67/02; C08G 63/183; C08G 63/672; C08J 9/00; A43B 13/04; C08J 9/12

(52) U.S. Cl. CPC C08L 67/02; C08G 63/183; C08G 63/672; C08J 9/0023; C08G 2101/00; C08J 9/0061; C08J 9/122; C08L 2203/14; C08G 2110/005; A43B 13/04

(57) ABSTRACT

The invention relates to a foam comprising thermoplastic copolyester elastomer in an amount of at least 60 wt % with respect to the total weight of the foam, wherein the thermoplastic copolyester elastomer has a number average molecular weight (Mn) of at least 34000 g/mol and a shore D hardness measured at 3 s of between 28 to 50. The invention further relates to a process for preparing the foam and articles comprising the foam.

This invention relates to a foam, an article comprising the foam, as well as a process for preparing the foam.

Foams comprising thermoplastic copolyester elastomers are known and are for example described in WO2018134166. A disadvantage of these foams is that they contain plasticizer, which may leach out. US2016/0297943 also describes foams, however, these densities are rather high.

It is thus an object of the present invention to provide a foam which exhibits low densities, while needing a lower amount of plasticizer, or even not needing plasticizer at all. This object is achieved by a foam comprising thermoplastic copolyester elastomer in an amount of at least 60 wt % with respect to the total weight of the foam, wherein the thermoplastic copolyester elastomer has a number average molecular weight (Mn) of at least 34000 g/mol and a shore D hardness measured at 3 s of between 28 to 50.

Surprisingly, the inventors have found that when the foam comprises thermoplastic copolyester elastomer wherein the thermoplastic copolyester elastomer has a number average molecular weight (Mn) of at least 34000 g/mol and a shore D hardness measured at 3 s of between 28 to 50, low densities can be obtained, while the foam is showing less defects. Defects may for example be cracks, both internally as well as on the surface, wrinkles, collapse of foam and combinations thereof. The inventors have shown that the foaming temperature during the process for preparing a foam may be increased thereby attaining lower densities with less defects. Without wishing to be bound by theory the inventors believe that cracks are formed by overstretching of cell walls, causing rupture and cascading failure of cells leading to formation of a big bubble. After foaming, a bubble is usually visible, which disappears over time, and leaving a so-called crack. Such an interior crack can also form in roughly spherical or elliptical pellets and after foaming it results in a hollow interior void which is apparent when the foamed bead is cross-sectioned. Cracks may exist only in the interior of the sample and/or they can extend all the way to the surface of the part. Cracks are unattractive and are to be avoided. Wrinkling is a phenomenon known per se and gives an undesirable appearance and/or increased density. Collapse of foam is also undesirable, as it increases the density and negatively influences the part geometry.

The foam “comprises thermoplastic copolyester elastomer” is herein understood to comprise at least one type of thermoplastic copolyester elastomer and includes comprising at least two types or even more types of thermoplastic copolyester elastomers.

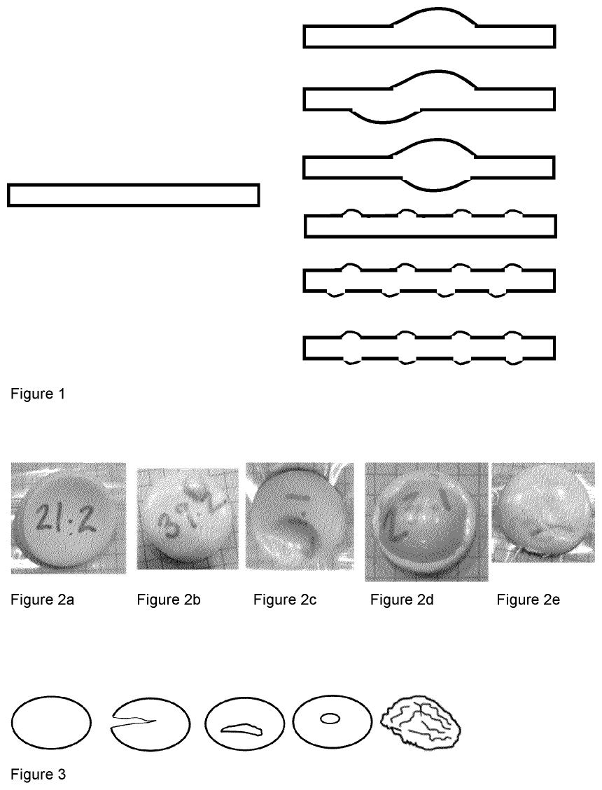

FIG. 1 provides a representation of crack formation by providing representations of foam cross-sections when inspected directly after foaming. Left column is a sample without cracks and on the right column samples are depicted with indication of cracks.

FIG. 2 provides photographs of samples directly after foaming. FIG. 2a is a photograph of a sample without cracks. FIGS. 2b-2e provide photographs of samples in which bubbles are present, indicating the presence of interior cracks.

FIG. 3 provides a representation of crack formation in beads, by providing representation of foam bead cross-sections. Left is a bead without cracks and the 3 further beads all exemplify a bead with cracks. The furthest right representation provides an example of a wrinkled bead.

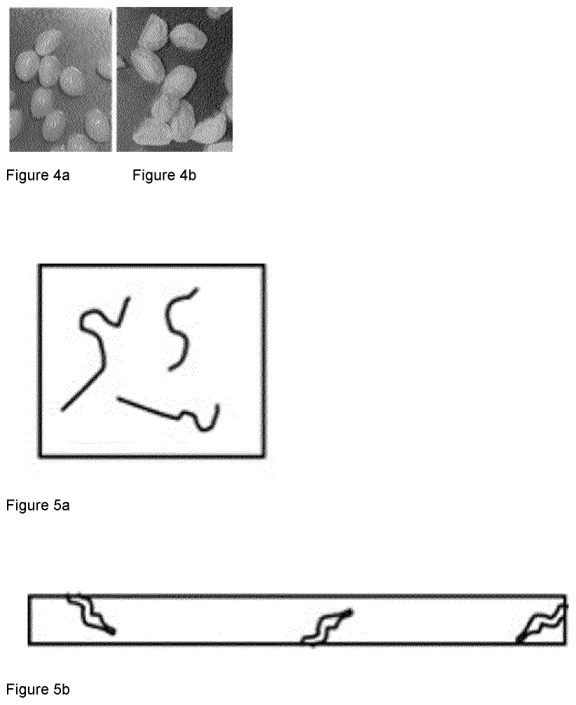

FIG. 4 provides photographs of foamed beads a day after foaming. 4a is a photograph of foamed beads according to the invention without damages. 4b is a photograph of damaged beads exhibiting wrinkling and collapse and are thus not according to the invention.

FIG. 5 provides a representation of a sample foamed plate where cracks have extended through the surface. 5a shows top view and 5b shows a cross-section of a plate.

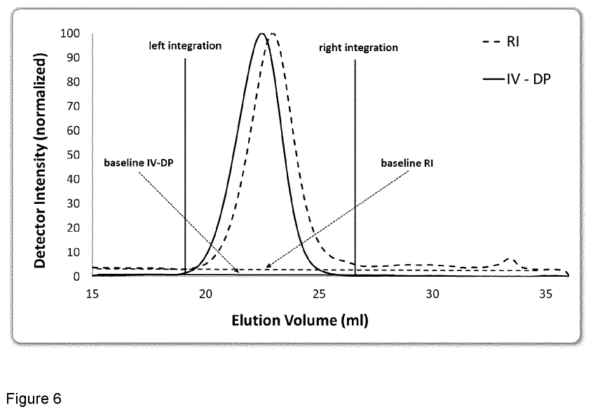

FIG. 6 provides an example of SEC chromatogram with integration limit (vertical lines) and baseline (horizontal lines) settings for determination of the molar mass moments and the molar mass distribution values, based on refractive index (RI) and differential viscosity chromatograms (IV-DP).

Lower density foams with fewer defects are very attractive as it is an important selling argument in applications where light-weight is favorable, for example sports shoes.

A foam is herein understood to be known to a person skilled in the art and relates to an object formed by trapping pockets of gas in a solid. Preferably a foam has a density of at most 0.7 g/cm³. A foam may be closed celled or open celled or a mixture of open and closed cells. “Foam comprising thermoplastic copolyester elastomer” is herein also referred to as a foamed composition. If the foam consists substantially of the thermoplastic copolyester elastomer, then the foamed composition consists substantially of the thermoplastic copolyester.

In one embodiment, the foam comprises thermoplastic copolyester elastomer in an amount of at least 60 wt %, preferably at least 70 wt %, with respect to the total weight of the foam, wherein the thermoplastic copolyester elastomer has a number average molecular weight (Mn) of at least 34000 g/mol and a shore D hardness measured at 3 s of between 28 to 50 and wherein the thermoplastic copolyester elastomer comprises hard segments built up from polyester repeating units derived from at least one aliphatic diol and at least one aromatic dicarboxylic acid or an ester thereof and soft segments being polytetramethylene oxide and wherein the foamed composition has a relative solution viscosity (RSV) of at least 4.1 as measured according to ISO 1628-5:2015. In another embodiment, the hard segments are chosen from the group consisting of ethylene terephthalate (PET), propylene terephthalate (PPT), butylene terephthalate (PBT), polyethylene bibenzoate, polyethelyene naphatalate (PEN), polybutylene bibenzoate, polybutylene naphatalate, polypropylene bibenzoate and polypropylene naphatalate and combinations thereof, preferably the hard segments are PBT or PET. Most preferred, the hard segment is butylene terephthalate (PBT), as thermoplastic copolyester elastomers comprising hard segments of PBT exhibit favourable crystallisation behaviour and a high melting point, resulting in thermoplastic copolyester elastomer with good processing properties and excellent thermal and chemical resistance. In a preferred embodiment the RSV of the foamed composition is at least 4.2, more preferably at least 4.3 and even more preferred at least 4.5, and most preferred at least 5.0. In yet another embodiment, the foamed composition further comprises a plasticizer in an amount of at most 30 wt % with respect to the total weight of foamed composition. Suitable plasticizers are listed below. In yet another embodiment, the foamed composition has a density of between 0.1 to 0.7 g/cm³, preferably between 0.10 to 0.50 g/cm³ and even more preferred between 0.11 and 0.30 g/cm³.

With “the foamed composition having an RSV” is hereby understood the RSV of the foamed composition as such and excludes glues, resins and other materials used to for example combine foamed compositions. These other components may have a different RSV and should be removed prior to the measurement of the RSV of the foamed composition or foam.

Relative solution viscosity (RSV) is measured according to ISO 1628-5:2015. The RSV of the foamed composition is measured at a concentration of 1 gram of foamed composition in 100 gram of m-cresol at 25.00+0.05° C. In general, the RSV is measured at a concentration of 1 gram of polymer in 100 gram of m-cresol at 25.00+0.05° C. Viscometer of the suspended level Ubbelohde type (e.g. DIN Ubbelohde from Schott (ref. no. 53023), capillary No IIc, capillary diameter 1.50 mm, capillary constant 0.3; (appendix 3)) is used. For high molar mass samples, it may be that the maximum efflux time of the equipment (combination of Ubbelohde type and measuring device) is exceeded. In those cases the concentration is to be reduced to e.g. 0.5 g/dl, allowing to do good measurements. For comparison reasons the obtained viscosity value is then recalculated to concentration of 1 g/dl using Huggins' equation with a Huggins' constant (kH) of 0.2616. An upper limit of the RSV is usually determined by the sensitivity of the instrument and the ability to dissolve the polymer or the foamed composition fully, which measures the RSV and may for example be at most 100.

The molecular weight of a thermoplastic copolyester elastomer can be increased by measures known to a person skilled in the art, such as for example by longer polymerization times, solid state post condensation, and/or by chain extension.

Solid state post condensation (SSPC) is a technique known to a person skilled in the art and involves heating of a polymer to a temperature which is below the melting temperature of the polymer, preferably after a compounding step with optional other ingredients, and keeping the polymer at an elevated temperature for a particular time while removing gaseous condensation products, usually between 4 and 60 hours, preferably between 12 and 50 hours. Usually, solid state post condensation is carried out on particles of the polymer, suitably pellets, but may also be performed on molded articles as such. SSPC may be carried out by any mode and in any apparatus suitable for that purpose, for example as a batch process, or a continuous process. An example of a batch process is employing a tumble dryer. An example of a continuous process is a moving bed reactor.

Increasing the molecular weight via chain extension is a technique known to a person skilled in the art. Chain extension can be obtained by reacting the end groups of oligomeric or polymeric molecules with a chain extender molecule which comprises reactive functional groups that are reactive towards the end groups of the oligomeric or polymeric molecules. The amount of reactive functional groups on the chain extender should be equal to, or greater than 2 to obtain a suitable increase in molecular weight. The chain extension reaction can be obtained by, for example, melt kneading of the different components. Chain extension can for example be obtained by melt kneading using an extruder. An example describing chain extension of a thermoplastic copolyester via reactive extrusion using di-isocyanates is given in Cho, S., Jang, Y., Kim, D., Lee, T., Lee, D. and Lee, Y., 2009. High molecular weight thermoplastic polyether ester elastomer by reactive extrusion. Polymer Engineering & Science, 49(7), pp.1456-1460. Another example of chain extension using diisocyanates can be found in WO9951656. An example of chain extension of polymers using bisoxazines can be found in WO05028541. Cardi et al. (J. Applied Polymer Science, Vol. 50, pp 1501-1509, 1993) discloses the chain extension of poly(ethylene terephthalate) with 2,2′-bis(2-oxazoline). U.S. Pat. No. 4,857,603 discloses the chain extension of poly(ethylene terephthalate) with polylactams.

Number average molecular weight (Mn), weight average molecular weight (Mw) can be determined by size exclusion (SEC) method, as explained below. SEC method for molar mass determination is generally described in ASTM: D5296-11 (2011).

Additionally, ASTM norm D 5226-98 (2010) defines solvents, which can be used for polymer analysis. For thermoplastic copolyester elastomers the solvent hexafluoroisopropanol containing 0.1 wt. % potassiumtriflouroacetate is employed.

The foam comprises thermoplastic copolyester elastomer in an amount of at least 60 wt % with respect to the total weight of the foam, wherein the thermoplastic copolyester elastomer has a number average molecular weight (Mn) of preferably at least 37000 g/mol, more preferably at least 40000 g/mol and most preferred at least 42000 g/mol. An upper limit for the number average molecular weight of the thermoplastic copolyester usually depends on the polymerization time and degradation due to long polymerization times and the Mn may be as high as 200000 g/mol, preferably at most 150000 g/mol and even more preferred at most 100000 g/mol.

The foam comprises thermoplastic copolyester elastomer in an amount of at least 60 wt % with respect to the total weight of the foam, wherein the thermoplastic copolyester elastomer has a shore D hardness measured at 3 s of between 28 and 50, more preferably between 30 and 45 and even more preferred between 31 and 40. Hardnesses below 28 Shore D usually lead to foams which may exhibit large post foaming shrinkage, which is not desirable for reaching a low final density. Hardnesses above 50 Shore D may lead to higher foaming temperatures, high foaming pressures, and limited initial expansion, which is also not desirable.

Shore D hardness is measured as described in ISO 868:2003(E) with the following deviations described below. The indenter should confirm to the geometry descripted in FIG. 2 of the norm ISO 868:2003(E) for type D durometers and should be calibrated according to the description in the norm.

The scale of the indicating device should be read after 3 s+/−1 s rather than 15 s+/−1 as described in section 8.1 of ISO 868:2003(E). Samples should be measured under ambient lab conditions (23° C., 50% relative humidity) and the samples shall be conditioned for at least one hour prior to testing. Place the test specimen on a hard, horizontal, plane surface. Hold the durometer in a vertical position with the point of the indenter at least 9 mm from any edge of the test specimen. Apply the presser foot to the test specimen as rapidly as possible, without shock, keeping the foot parallel to the surface of the test specimen. Apply just sufficient pressure to obtain firm contact between presser foot and test specimen.

The sample thickness shall be between 4 and 6 mm. Thinner samples may be stacked such that the total stack thickness is between 4 and 6 mm. As stacking requires samples to be flat to ensure as complete contact as possible between the pieces, for this reason if samples are stacked the individual samples should not have a thickness less than 2 mm. Thus, for example, it is permissible to measure a sample with a thickness of between 4 and 6 mm or by stacking 2 samples with a thickness of between 2 and 3 mm to achieve a total stack thickness of between 4 and 6 mm.

Samples should be prepared via compression molding or injection molding such that the surfaces are sufficiently smooth and the sample thickness substantially uniform. The sample surface should be substantially flat over an area sufficient to permit the presser foot to be in contact with the test specimen over an area having a radius of at least 6 mm from the indenter.

Compression molding conditions should be selected such as that a substantially uniform plate sample is obtained. The minimum temperature required to obtain a defect free sample should be used as higher temperatures can lead to degradation of the material. The samples should be cooled under pressure in the press. Teflon release liners can be used between the sample and the press to ensure smooth surfaces.

The foam comprises thermoplastic copolyester elastomer in an amount of at least 60 wt %, preferably at least 65 wt % with respect to the total weight of the foam, more preferably at least 70 wt %, even more preferred at least 75 wt % and most preferred at least 80 wt % with respect to the total weight of the foam. The foam may also consist of the thermoplastic copolyester elastomer, thus wherein the amount is substantially 100 wt %. The amount refers to the total amount of thermoplastic copolyester elastomer and may also refer to a blend if more than one type of thermoplastic copolyester elastomer is employed.

Preferably, the foam comprises thermoplastic copolyester elastomer wherein the thermoplastic copolyester elastomer has a Mw/Mn of less than 2.7. This has the advantage that the polymer is less branched which may reduce formation of cracks in the foaming process. More preferably the thermoplastic copolyester elastomer has an Mw/Mn of less than 2.4. For thermoplastic copolyesters made via condensation polymerization Mw/Mn is at least 1, preferably at least 1.8.

All Size Exclusion Chromatography measurements are performed on Viscotek GPCMax VE2001 solvent/sample module system, equipped with TDA302 triple detector array. For chromatographic separation, 3 PFG linear XL columns from PSS Polymer Standards Service GmbH are used. Detectors and columns are operated at 35° C. Prior Size Exclusion Chromatography, polymer is dissolved at concentration ranging from 1.0 to 1.5 mg/ml in hexafluoroisopropanol containing 0.1 wt. % potassiumtriflouroacetate, which is also used as an eluent in SEC analysis at a flow rate of 0.8 ml/min. The molar mass and molar mass distribution are determined with triple detection method, using the refractive index, differential viscosity and right-angle light scattering signals. For calculation of molecular weight averages (Mn is number average molecular weight, Mw is weight average molecular weight and Mz is Z average molecular weight) and molar mass distribution, refractive index indices (dn/dc's) in a range of 0.22 to 0.24 ml/g are used. The refractive index indices are determined by integration of the whole refractive index chromatograms. Integration limits for molar mass moments and molar mass distribution calculations are set by taking into account the beginning and the end of the differential viscosity chromatogram recorded for a sample of interest. FIG. 6 provides an example of integration limit setting. Further details for these calculations can be found in Niehaus, D. E., Jackson, C. “Size exclusion chromatography of step-growth polymers with cyclic species: theoretical model and data analysis methods”, Polymer 41 (2000), 259-268.

A thermoplastic copolyester elastomer is herein understood to be a copolymer comprising hard segments built up from polyester repeating units derived from at least one aliphatic diol and at least one aromatic dicarboxylic acid or an ester thereof, and soft segments.

Soft segments are herein understood to originate from aliphatic diols and aliphatic diacids having an Mn of at least 300 g/mol. Mn can be measured by performing end group titrations or NMR spectroscopy, as for example described in J. Serb. Chem. Soc. 66 (3) 139-152 (2001). Suitable soft segments include for example polytetramethylene oxide (PTMO), polyethylene oxide (PEO), polypropylene oxide (PPO), block copolymers of poly(ethylene oxide) and poly(propylene oxide), linear aliphatic polycarbonates, polybutylene adipate (PBA) and derivates of dimer fatty acids or dimer fatty acid diols, linear aliphatic polyesters and combinations thereof.

An example of suitable linear aliphatic polycarbonates is polyhexamethylene carbonate (PHMC). Preferably, the soft segment is a block copolymers of poly(ethylene oxide) and poly(propylene oxide), such as for example PEO-PPO-PEO or polytetramethylene oxide (PTMO). Most preferred the soft segment is PTMO due to its low glass transition temperature, and limited moisture uptake.

Preferably, the soft segment is PTMO and the foamed composition has an RSV of at least 4.1, preferably at least 4.2, more preferably at least 4.3 and even more preferred at least 4.5, and most preferred at least 5.0, as measured according to ISO 1628-5:2015, as low densities can be obtained, while the amount of cracks is kept low, or may even be absent.

Preferably, the soft segment has a number average molecular weight (Mn) of not less than 500 g/mol and not more than 5000 g/mol, as this has the advantage that suitable melting points can be obtained without melt phasing during polymerization of the thermoplastic copolyester elastomer. The number average molecular weight can be measured for a soft segment by NMR spectroscopy.

Soft segments may be present in the thermoplastic copolyester elastomer in various amounts and depends on the required hardness and melting temperature. Preferably, the thermoplastic copolyester elastomer comprises between 10 and 80 wt % of soft segment, wherein wt % is with respect to the total weight of the thermoplastic copolyester elastomer. More preferably, the amount of soft segment is between 20 to 75 wt % and even more preferred between 30 and 65 wt %.

Hard segments are built up from polyester repeating units derived from at least one aliphatic diol and at least one aromatic dicarboxylic acid or an ester thereof and optionally minor amounts of other diacids and/or diols.

Aliphatic diols contain generally 2-10 C-atoms, preferably 2-6 C-atoms. Examples thereof include ethylene glycol, 1,2-propylene glycol, 1,3-propylene glycol, butylene glycol, 1,2-hexane diol, 1,6-hexamethylene diol, 1,4-butanediol, 1,4-cyclohexane diol, 1,4-cyclohexane dimethanol, and mixtures thereof. Preferably, 1,4-butanediol is used.

Suitable aromatic dicarboxylic acids include terephthalic acid, isophthalic acid, phthalic acid, 2,6-naphthalenedicarboxylic acid and 4,4′-diphenyldicarboxylic acid, and mixtures thereof.

The hard segment preferably has as repeating unit chosen from ethylene terephthalate (PET), propylene terephthalate (PPT), butylene terephthalate (PBT), polybutylene isophthalate (PBI), polyethylene isophthalate (PEI), polyethelyene naphthalate , polybutylene naphthalate , and polypropylene naphthalate and combinations thereof. Preferably, the hard segment is PET, PBT, PEI, PBI and combinations thereof.

Preferably, the hard segment is PET or PBT, optionally in combination with PEI or PBI. More preferably, the hard segment is PBT optionally in combination with PBI, as thermoplastic copolyester elastomers comprising hard segments of PBT exhibit favourable crystallisation behaviour and a high melting point, resulting in thermoplastic copolyester elastomer with good processing properties and excellent thermal and chemical resistance wherein PBI hard segments may be used to fine tune the melting temperature and crystallization behavior.

The thermoplastic copolyester elastomer may contain minor amounts of comonomers, such as branching agents and/or chain extenders, as well as catalysts or stabilizers, which are usually employed during preparation of the thermoplastic copolyester elastomer. With minor amounts is herein understood to be at most 10 wt % with respect to the total amount of thermoplastic copolyester elastomer, preferably at most 5 wt %. Examples of suitable chain extenders are molecules comprising two or more functional groups such as for example oxazolines, epoxides, isocyanates, lactams, ketenimines, anhydrides, oxazolinones and cyanates. Preferably diisocyanates are used. Usual difunctional isocyanates are, inter alia, paratoluene diisocyanate, diphenylmethane diisocyanate (MDI), xylylene diisocyanate, hexamethylene diisocyanate or isophorone diisocyanate, or isomers thereof.

Preferably, the foam comprises thermoplastic copolyester elastomer wherein the thermoplastic copolyester elastomer has a melting temperature (Tₘ) of at least 150° C., more preferably at least 155° C. and even more preferred at least 160° C., as this has the advantage that it provides a wider foaming process window as well as wider temperature range for foam use.

The melting temperature (Tₘ) of the thermoplastic copolyester elastomer is routinely determined using differential scanning calorimetry (DSC) according to ISO 11357-3:2011. The melting temperature is defined as the peak temperature (e.g. the maximum height in the endotherm from the associated chromatogram) of the highest temperature melting peak determined using a heating rate of 10° C./min on the second heating. The instrument should be calibrated by an indium standard. Aluminum pans are employed to hold a small portion of the thermoplastic copolyester elastomer, preferably between 5 and 10 mg. The samples are heated at a constant rate of 10° C./min to a temperature at least 20° C. above the highest melting temperature, preferably at least 240° C. The sample is then cooled at a rate of 10° C./min to a temperature of at most 0° C., more preferably at most −50° C. to erase any variable thermal history. The sample is then heated again at a constant rate of 10° C./min to a temperature at least 20° C. above the highest melting temperature, preferably to at least 240° C.

The foam may comprise further ingredients, which should not drastically increase the hardness of the foam. Further ingredients may include colorants, pigments, nucleating agents, flame retardants, UV stabilizers, heat stabilizers, plasticizers, and further polymers. Polymers include for example polyolefin rubbers including for example ethylene propylene diene monomer rubber (EPDM), polyolefin elastomer (POE), block olefin copolymers (BOC), ethylene-propylene rubber (EPR) as well as other types of rubber such as for example styrene-ethylene-butylene-styrene copolymers (SEBS), ethylene-vinyl acetate (EVA), thermoplastic polyurethane elastomer (TPE-U), thermoplastic polyamide elastomer (TPE-A) etc. and the grafted rubber based on these, as well as combinations thereof.

Plasticizers are known substances to a person skilled in the art per se, and commonly refer to molecules which are liquid at room temperature and for example lowers the hardness and/or increases the strain at break of a composition as compared to the elastomer itself. Preferably the amount of plasticizer is less than 30 wt % based on the total amount of foam, more preferably less than 25 wt % and even more preferred less than 20 wt % and even more preferred less than 12 wt %, and even more more preferred less than 5 wt %, and most preferred the foam does not contain plasticizers. In a process for preparing a foam, the weight percentages above relate to the composition employed in the process.

Plasticizers include for example phthalate esters, dibasic acid esters, mellitates and esters thereof, cyclohexanoate esters, citrate esters, phosphate esters, modified vegetable oil esters, benzonate esters, and petroleum oils, and combinations thereof.

Examples of phthalates include dioctyl phthalate, dibutyl phthalate, diethyl phthalate, butylbenzyl phthalate, di-2-ethylhexyl phthalate, diisodecyl phthalate, diundecyl phthalate, diisononyl phthalate, diethyl hexyl terephthalate (DEHT), dioctyl terephthalate, dibutyl terephathalate.

Examples of dibasic acid esters include di-2-ethylhexyl adipate (DEHA), dioctyl adipate, diisobutyl adipate, dibutyl adipate, diisodecyl adipate, and dioctyl sebacate.

Examples of mellitates and esters thereof include trioctyl trimellitate and trimellitic acid tri-2-ethylhexyl.

Example of phosphate esters include Triphenyl phosphate (TPP), tert-Butylphenyl diphenyl phosphate (Mono-t-but-TPP), di-tert-butylphenyl phenyl phosphate (bis-t-but-TPP), Tris(p-tert-butylphenyl) phosphate (tri-t-but-TPP), Resorcinol bis (Diphenyl Phosphate) (RDP), dichloropropyl phosphate, Bisphenol A bis-(Diphenyl Phosphate) (BDP), tricresyl phosphate (TCP), triethyl phosphate, tributyl phosphate (TBP), tri-2-ethylhexyl phosphate, trimethyl phosphate and combinations thereof. A blend of TPP, mono-t-But-TPP, Bis-t-But-TPP, Tri-t-But-TPP is also known under the name Phosflex 71B HP and is particularly suitable, as it is easily mixed with the thermoplastic elastomer.

Examples of modified vegetable oil esters include epoxidized soybean oil (ESO), epoxidized palm oil (EPO), epoxidized linseed oil (ELO) and Argan oil.

Preferably, if plasticizers are being employed, phosphate esters and modified vegetable oil esters are being employed, as these are commonly used plasticizers and easily processable.

The invention also relates to a process for preparing a foam, comprising the following steps:
a) Providing a composition comprising thermoplastic copolyester elastomer in an amount of at least 60 wt % with respect to the total weight of composition, wherein the thermoplastic copolyester elastomer has a number average molecular weight (Mn) of at least 34000 g/mol and a shore D hardness measured at 3 s of between 28 to 50;
b) Bringing the composition to a foaming temperature of between (Tm-100) ° C. and Tm, in which Tm is the melting temperature of the thermoplastic copolyester elastomer as measured according to ISO 11357-3:2011 DSC in the second heating curve, with a heating and cooling rate of 10° C. per min under nitrogen atmosphere;
c) Providing a physical blowing agent under pressure to the composition;
d) Releasing the pressure thereby obtaining the foam.

The preferred embodiments of the foams as disclosed above are herewith explicitly combinable with the process as disclosed above.

In one embodiment, the invention relates to a process for preparing a foamed composition, comprising the following steps:
a) Providing a composition comprising a thermoplastic copolyester elastomer, wherein the thermoplastic copolyester elastomer comprises hard segments built up from polyester repeating units derived from at least one aliphatic diol and at least one aromatic dicarboxylic acid or an ester thereof, and soft segments being polytetramethylene oxide and wherein the RSV of the composition is at least 4.1, and wherein the thermoplastic copolyester elastomer has a number average molecular weight (Mn) of at least 34000 g/mol and a shore D hardness measured at 3 s of between 28 to 50; more preferably the RSV of the composition is at least 4.2, more preferably at least 4.3 and even more preferred at least 4.5, and most preferred at least 5.0;
b) Bringing the composition to a foaming temperature of between (Tm-100) ° C. and Tm, in which Tm is the melting temperature of the hard segment of the thermoplastic copolyester elastomer composition as measured according to ISO 11357-1:2009 DSC in the second heating curve, with a heating and cooling rate of 10° C. per min under nitrogen atmosphere;
c) Providing a physical blowing agent under pressure to the composition;
d) Releasing the pressure thereby forming the foamed composition.

In step a) a composition is provided. This may be in various forms, and for example includes granules, pellets, beads, chips, plaques, pre-form, film, sheet etc.

The composition comprises thermoplastic copolyester elastomer with properties as disclosed above for the foam. After the process a foamed composition is formed, which is also referred to as “foam”.

The process may further comprise additional steps after step d) to further process the foam, such as cutting a form out of the foam, and/or combining foam into parts, such as for example by steam moulding, high frequency welding, incorporation into a matrix and other consolidation techniques.

The foam may be in the form of foamed beads, and subsequently consolidated by for example heating with steam to mould the foamed beads together into a part in for example a mold or consolidated by other techniques. A mold may be filled with foam in various forms, such as foamed beads, and subsequently steam is injected, sintering the foam together to form a part. Foam in the form of beads, usually have dimensions of between 1.0 and 15.0 mm, preferably between 2.0 and 10 mm and most preferred between 3.0 and 7.0 mm.

The process is particularly suitable for a composition comprising thermoplastic copolyester elastomer comprising hard segments being PBT optionally in combination with PBI, and soft segments being PTMO or PEO-PPO-PEO, and an optional plasticizer is chosen from Triphenyl phosphate (TPP), tert-Butylphenyl diphenyl phosphate (Mono-t-but-TPP), di-tert-butylphenyl phenyl phosphate (bis-t-but-TPP), Tris(p-tert-butylphenyl) phosphate (tri-t-but-TPP), Resorcinol bis (Diphenyl Phosphate) (RDP), dichloropropyl phosphate, Bisphenol A bis-(Diphenyl Phosphate) (BDP), tricresyl phosphate (TCP), triethyl phosphate, tributyl phosphate (TBP), tri-2-ethylhexyl phosphate, trimethyl phosphate, epoxidized soybean oil (ESO), epoxidized palm oil (EPO), epoxidized linseed oil (ELO) and argan oil and combinations thereof.

With “bringing the composition to a foaming temperature” is herein understood to encompass both heating as well as cooling to come to the desired temperature.

Step b) and c) can be done simultaneously, or first b) and then c), or first c) and then b) in which step b) has to be performed under a pressure to prevent the composition from foaming. An example when step c) is performed before step b), is when, the physical blowing agent is added under pressure (step c) while the composition is in a molten state, after which the composition is injected in a cavity (a mold) and cooled, while kept under pressure, to the foaming temperature (step b). One of the possible advantages of such a process is faster take up of the physical blowing agent by the composition. The necessary soaking time should be adjusted to achieve a substantially uniform distribution of blowing agent as is known by those skilled in the art to vary with for example temperature, sample thickness, composition, and physical blowing agent type.

Before step b), the composition may be molded into a pre-form, by processes such as molding.

With physical blowing agent is herein understood to be a substance which may dissolve in the composition, without reacting or decomposing. Physical blowing agent may for example be chosen from hydrocarbons such as pentane, isopentane, cyclopentane, butane, isobutene and CO₂ and nitrogen as well as mixtures thereof. Typical pressures for CO₂ in step c are between 100 bar and 200 bar.

In step b) the composition is brought to a foaming temperature of between (Tm-100) ° C. and Tm, in which Tm is the melting temperature of the thermoplastic copolyester elastomer as measured according to ISO 11357-3:2011 DSC in the second heating curve, with a heating and cooling rate of 10° C. per min under nitrogen atmosphere. This may be performed by heating or cooling depending on the temperature employed before step b). If the composition comprises more than one type of thermoplastic copolyester elastomer, the melting temperature Tm is defined as the peak temperature of the melting peak at the highest temperature.

The foaming temperature in step b) is preferably at most (Tm-5) ° C., more preferably at most (Tm-10) ° C., most preferred at most (Tm-15) ° C., and preferably at least (Tm-80) ° C., more preferably at least (Tm-60) ° C., most preferred at least (Tm-40) ° C., as this provides foams with lower densities.

When step b) is a heating step, the heating is preferably done to a temperature of at most (Tm-5) ° C., more preferably at most (Tm-10) ° C., most preferred at most (Tm-15) ° C. The heating in step b) preferably done to a temperature of at least (Tm-80) ° C., more preferably at least (Tm-60) ° C., most preferred at least (Tm-40) ° C., as this provides foams with lower densities. Heating is usually performed by an external heat source while keeping the composition in a pressure vessel.

Step b) may also be a cooling step, in which the temperature is lowered to a foaming temperature of at most (Tm-5) ° C., more preferably at most (Tm-10) ° C., most preferred at most (Tm-15) ° C. The foaming temperature is preferably cooled to at least (Tm-80) ° C., more preferably at least (Tm-60) ° C., most preferred at least (Tm-40) ° C. An example of cooling may be when a composition is molded into a pre-form at a temperature above the foaming temperature.

Step d) is preferably done in manner so that the pressure is released as fast as possible, preferably pressure drop of at least 100 Bar per second, more preferably at least 500 Bar per second.

The process to prepare the foam as described above is generally known as a batch foaming or solid-state foaming process and is to be distinguished from extrusion foaming. In a process for extrusion foaming the composition is generally to be heated to above its melting temperature.

Surprisingly, the process resulted in foams exhibiting less defects, which allowed for very low-density foams, as the composition allowed for higher foaming temperatures.

The foam according to the invention can further be processed by methods known per se by a person skilled in the art, such as for example by embedding foam in a matrix and forming into the desired shape, such as for example by molding. Another further processing step may be treating foam with steam and subsequently forming into a desired shape, also known as steam chest molding. This is particularly suitable for foamed beads as elaborated above.

The foam is very suitable for application in articles for sport goods, such as shoe soles, preferably inner shoe soles or midsoles, seating, matrasses, golf balls, as the article shows a combination of low density and a high energy return. The invention thus also relates to an article comprising the foam as disclosed above.

Surprisingly the foam comprising thermoplastic copolyester elastomer as disclosed above has a density of preferably between 0.05 to 0.70 g/cm³, more preferably between 0.06 to 0.50 g/cm³ and even more preferred between 0.07 and 0.30 g/cm³, allowing for foams exhibiting less defects. Lower densities allow for lighter material.

### EXAMPLES

### Injection Molded Materials

### Materials Used

Thermoplastic copolyester elastomers with PBT based hard segments as disclosed in Table 1 were used in a foaming process. Weight percentage in Table 1 is given with respect to the total weight of thermoplastic copolyester elastomer. Properties of these thermoplastic copolyesters is given in Table 1. Polymer 1 was obtained by solid state post-condensing polymer A and polymer 2 was obtained by solid state post-condensing polymer B.

TABLE 1
thermoplastic copolyester elastomers and its properties

| | Type of | | wt % of | | | Hardness | Hardness | | | | |
|---|---|---|---|---|---|---|---|---|---|---|---|
| | Soft | Mn of soft | soft | | DSC | Shore D | Shore D | Mn | Mw | Mz | Mw/Mn |
| Material | Segment | segment | segment | RSV | Tₘ (° C.) | (15 s) | (3 s) | (g/mol) | (g/mol) | (g/mol) | (—) |
| Polymer A | PTMO | 2000 | 60 | 3.4 | 195 | 33 | 35 | 29400 | 59100 | 97000 | 2.0 |
| Polymer B | PEO- | 2300 | 55 | 2.8 | 212 | | 33 | 31400 | 62600 | 99000 | 2.0 |
| | PPO- | | | | | | | | | | |
| | PEO | | | | | | | | | | |
| Polymer 1 | PTMO | 2000 | 60 | 6.26 | 195 | 33 | 35 | 56000 | 112000 | 167000 | 2.0 |
| Polymer 2 | PEO- | 2300 | 55 | 3.75 | 212 | | 32 | 44100 | 89000 | 132000 | 2.0 |
| | PPO- | | | | | | | | | | |
| | PEO | | | | | | | | | | |

Relative solution viscosity (RSV) was measured according to ISO 1628-5:2015. The RSV is measured at a concentration of 1 gram of polymer in 100 gram of m-cresol at 25.00+0.05° C. Viscometer of the suspended level Ubbelohde type (e.g. DIN Ubbelohde from Schott (ref. no. 53023), capillary No IIc, capillary diameter 1.50 mm, capillary constant 0.3; (appendix 3)) was used. For high molar mass samples, it may be that the maximum efflux time of the equipment (combination of Ubbelohde type and measuring device) is exceeded. In those cases the concentration is to be reduced to e.g. 0.5 g/dl, allowing to do good measurements. For comparison reasons the obtained viscosity value is then recalculated to concentration of 1 g/dl using Huggins' equation with a Huggins' constant (kH) of 0.2616.

The RSV of Polymer 1 was so high that it had to be measured at 0.5 g/dl and then was recalculated to 1 g/dl. All other RSV values were directly measured at 1 g/dl.

Shore D hardness and Mn, Mw and Mz were measured according to the method as described above.

### Sample Preparation

Plates were injection molded from thermoplastic copolyester elastomers as disclosed in Table 1, with lateral dimensions of 80*80 mm and various thicknesses as listed in Table 2. Rectangular samples with lateral dimensions of between 10 and 20 mm were cut out of these plates for foaming tests.

### Foaming Process

The sample with dimensions and thickness as listed in Table 2 was placed in a pressure vessel that was electrically heated to the foaming temperature listed in Table 2.
Subsequently, cavity was filled with CO₂ at the pressure listed in Table 2 by a CO₂ canister connected to the pressure vessel via a booster pump
The sample was allowed to absorb CO₂ for the soaking time listed in Table 2.
The pressure vessel was opened, thus achieving a fast pressure drop resulting in the foamed composition.
Samples were visually inspected within one minute after opening the pressure vessel for defects, such as bubbles on the surface, indicating the presence of cracks in the interior of the sample. Samples were inspected a second time 24 hour after foaming for wrinkles or collapse. Examples of samples showing indications of cracks are depicted in FIG. 1 right column. The left column of FIG. 1 shows a sample containing no cracks. FIG. 4b provides a photograph of beads with wrinkling.
Volume of the sample was determined by measuring length, width, and thickness using a vernier gauge after allowing the sample to remain at ambient conditions for 24 hours after foaming to allow the CO₂ still present in the sample to diffuse out. Mass of the sample was determined by weighing and density of the sample was determined by dividing mass by volume.

TABLE 2
foaming conditions and properties of foams

| | | | | | | | | Properties foam | |
|---|---|---|---|---|---|---|---|---|---|
| | | Initial dimensions | | | Foaming conditions | | | final | |
| | | Length | Width | Thickness | Temperature | Pressure | Soaking time | density | |
| Experiment no. | Material | (mm) | (mm) | (mm) | (° C.) | (bar) | (min) | (g/cm³) | Damage |
| Comparative A1 | Polymer A | 15.5 | 15.6 | 3.07 | 145 | 200 | 25 | 0.34 | No |
| Comparative A2 | Polymer A | 15.55 | 15.52 | 3.05 | 150 | 200 | 25 | 0.27 | Yes - cracking |
| Example 1.1 | Polymer 1 | 20.384 | 17.3 | 2.96 | 145 | 200 | 25 | 0.42 | No |
| Example 1.2 | Polymer 1 | 20.95 | 20.17 | 2.98 | 165 | 200 | 25 | 0.28 | No |
| Example 1.3 | Polymer 1 | 20.39 | 20.68 | 2.99 | 170 | 200 | 25 | 0.23 | No |
| Example 1.4 | Polymer 1 | 20.00 | 20.25 | 2.98 | 175 | 200 | 25 | 0.16 | Yes - cracking |
| Comparative B1 | Polymer B | 20 | 19.5 | 2 | 145 | 190-210 | 10 | 0.36 | No |
| Comparative B2 | Polymer B | 19.7 | 19.4 | 2 | 150 | 190-210 | 10 | 0.32 | Yes - cracking |
| Comparative B3 | Polymer B | 19.5 | 19.4 | 2 | 155 | 190-210 | 10 | 0.28 | Yes - cracking |
| Comparative B4 | Polymer B | 20 | 20 | 2 | 160 | 190-210 | 10 | 0.25 | Ye s- cracking |
| Example 2.1 | Polymer 2 | 19.8 | 19.5 | 2.0 | 180 | 190-210 | 10 | 0.23 | No |
| Example 2.2 | Polymer 2 | 15 | 15 | 4 | 180 | 190-210 | 30 | 0.18 | No |
| Example 2.3 | Polymer 2 | 15.3 | 15.3 | 2.0 | 190 | 190-210 | 10 | 0.15 | No |
| Example 2.4 | Polymer 2 | 9.7 | 10.0 | 2.0 | 195 | 190-210 | 10 | 0.14 | No |

The examples in Table 2 demonstrate that thermoplastic copolyester elastomers with Mn of at least 34000 g/mol were able to be foamed to lower densities without exhibiting damage, than thermoplastic copolyester elastomers with Mn of less than 34000 because higher foaming temperatures could be used before cracking was observed. Polymer 1 could be foamed to a density of 0.23 g/cm³ without damage. Further increasing the foaming temperature to 175° C. lead to cracking of the foam. In contrast, Polymer B could only be foamed to a density of 0.36 g/cm³. Increasing the foaming temperature to 150° C. resulted in cracks.

### Pressed Plates

### Materials Used

Thermoplastic copolyester elastomers with PBT/PBI based hard segments as disclosed in Table 3 were used in a foaming process. Weight percentage in table 3 is given with respect to the total weight of thermoplastic copolyester elastomer. Properties of the thermoplastic copolyesters is given in Table 3. Polymer 3 and 4 were obtained by chain extension of polymer C using di-isocyantes. Polymer 6 was obtained by chain extension of polymer D using di-isocyantes.

TABLE 3
thermoplastic copolyester elastomers and properties

| | | | | | | Hardness | | | | |
|---|---|---|---|---|---|---|---|---|---|---|
| | Type of soft | Mn of soft | wt % of soft | | DSC Tₘ | Shore D | Mn | Mw | Mz | Mw/Mn |
| | segment | segment | segment | RSV | (° C.) | (3 s) | (g/mol) | (g/mol) | (g/mol) | (—) |
| Polymer C | PTMO | 1000 | 55 | 3.2 | 161 | 36 | 28500 | 56600 | 87000 | 2.0 |
| Polymer 3 | PTMO | 1000 | 55 | 3.7 | 164 | 38 | 38700 | 76000 | 121000 | 2.0 |
| Polymer 4 | PTMO | 1000 | 55 | 4.0 | 163 | 41 | 49500 | 114000 | 274000 | 2.3 |
| Polymer 5 | PTMO | 1000 | 44 | 3.3 | 149 | 40 | 34200 | 73000 | 217000 | 2.1 |
| Polymer 6 | PTMO | 1000 | 35 | 2.5 | 165 | 48.5 | 46700 | 96000 | 198000 | 2.1 |
| Polymer D | PTMO | 1000 | 35 | | 165 | 45.4 | 26300 | 52900 | 84000 | 2 |

### Sample Preparation

Plates were made via a hot-pressing procedure using a Fontijne press. First the upper and lower plates were pre-heated to 190 degrees C. A metal mold of 3 mm thickness with a square 12×12 cm cavity was sprayed with liquid Teflon on both sides and the inside of the cavity, excess liquid was removed. Thick glass-fiber-reinforced Teflon sheets of 1 mm thickness are used to help release of the samples. The metal mold with 25 grams of pellets in the center of the cavity is placed between these sheets and then the stack is placed onto the lower plate of the hot press. A vacuum is mounted to avoid degradation. After 15 minutes the upper place of the press is lowered until an applied force of 25 kN is reached. After 3 minutes the force is increased to 180 kN. While still under this applied force, the upper and lower plates of the press are cooled using a water circulation system. Once the sample reaches 37 C, the vacuum is disconnected, the press opened, and the plate extracted from the mold cavity. Cylindrical samples with either 8 mm or 15 mm diameter were then punched from the hot-pressed plates and used for the foaming experiments. The thickness is listed in Table 4.

Foaming was done analogous to “Foaming process” as described above, as well as the density measurement with the sample thickness and diameter being measured to determine the sample volume.

TABLE 4
foaming conditions and properties of foams

| | | Initial | | | | | Properties foam | |
|---|---|---|---|---|---|---|---|---|
| | | dimensions | | Foaming conditions | | | final | |
| | | diameter | thickness | Temperature | Pressure | Soaking time | density | |
| Experiment no. | Material | (mm) | (mm) | (° C.) | (bar) | (min) | (g/cm³) | Damage |
| Comparative C1 | Polymer C | 15 | 2.3 | 115 | 200 | 15 | 0.27 | Yes - cracking |
| Comparative C2 | Polymer C | 15 | 2.3 | 115 | 200 | 15 | 0.26 | Yes - cracking |
| Comparative C3 | Polymer C | 15 | 2.3 | 125 | 200 | 15 | 0.19 | Yes - cracking |
| Example 3.1 | Polymer 3 | 15 | 2.4 | 115 | 200 | 15 | 0.29 | No |
| Example 3.2 | Polymer 3 | 15 | 2.4 | 115 | 200 | 15 | 0.32 | No |
| Example 3.3 | Polymer 3 | 15 | 2.4 | 115 | 200 | 15 | 0.31 | No |
| Example 3.4 | Polymer 3 | 15 | 2.4 | 125 | 200 | 15 | 0.20 | No |
| Example 3.5 | Polymer 3 | 8 | 2.4 | 125 | 200 | 15 | 0.24 | No |
| Example 3.6 | Polymer 3 | 8 | 2.4 | 130 | 200 | 15 | 0.19 | No |
| Example 3.7 | Polymer 3 | 15 | 2.4 | 135 | 200 | 15 | 0.13 | No |
| Example 3.8 | Polymer 3 | 8 | 2.4 | 140 | 200 | 15 | 0.17 | Yes - wrinkle/collapse |
| Example 3.9 | Polymer 3 | 15 | 2.4 | 145 | 200 | 15 | 0.16 | Yes - wrinkle/collapse |
| Example 4.1 | Polymer 4 | 15 | 2.4 | 115 | 200 | 15 | 0.31 | No |
| Example 4.2 | Polymer 4 | 8 | 2.4 | 115 | 200 | 15 | 0.34 | No |
| Example 4.3 | Polymer 4 | 15 | 2.4 | 125 | 200 | 15 | 0.24 | No |
| Example 4.4 | Polymer 4 | 8 | 2.4 | 125 | 200 | 15 | 0.23 | No |
| Example 4.4 | Polymer 4 | 15 | 2.4 | 135 | 200 | 15 | 0.15 | No |
| Example 4.5 | Polymer 4 | 8 | 2.4 | 140 | 200 | 15 | 0.16 | Yes - wrinkle/collapse |
| Example 4.6 | Polymer 4 | 15 | 2.4 | 145 | 200 | 15 | 0.15 | Yes - wrinkle/collapse |
| Example 5.1 | Polymer 5 | 15 | 2.5 | 115 | 200 | 15 | 0.28 | No |
| Example 5.2 | Polymer 5 | 15 | 2.5 | 125 | 200 | 15 | 0.22 | No |
| Example 5.3 | Polymer 5 | 8 | 2.5 | 130 | 200 | 15 | 0.17 | No |
| Example 5.4 | Polymer 5 | 15 | 2.5 | 135 | 200 | 15 | 0.18 | Yes - wrinkle/collapse |
| Example 5.5 | Polymer 5 | 15 | 2.5 | 145 | 200 | 15 | Not able to | Yes - wrinkle/collapse |
| | | | | | | | measure | |
| Comparative D1 | Polymer D | 15 | 2.4 | 120 | 200 | 15 | 0.44 | No |
| Comparative D2 | Polymer D | 15 | 2.4 | 130 | 200 | 15 | 0.27 | No |
| Comparative D4 | Polymer D | 15 | 2.4 | 135 | 200 | 15 | 0.20 | Crack |
| Comparative D5 | Polymer D | 15 | 2.4 | 140 | 200 | 15 | 0.16 | Crack |
| Comparative D6 | Polymer D | 15 | 2.4 | 150 | 200 | 15 | 0.16 | Crack |
| Example 6.1 | Polymer 6 | 15 | 2.7 | 120 | 200 | 15 | 0.44 | No |
| Example 6.2 | Polymer 6 | 15 | 2.7 | 130 | 200 | 15 | 0.27 | No |
| Example 6.3 | Polymer 6 | 15 | 2.7 | 135 | 200 | 15 | 0.21 | No |
| Example 6.4 | Polymer 6 | 15 | 2.7 | 140 | 200 | 15 | 0.13 | No |

Table 4 demonstrates that increasing the Mn to at least 34000 via chain extension also provided foams with less cracks and allowed lower densities. A higher melting temperature of the thermoplastic copolyester elastomer allowed for wider foaming window before wrinkling or collapse was observed which allowed for lower final densities to be reached. The densities achieved were very consistent and the initial sample diameter had very little influence.

### Plates and Pellets

### Materials Used

Pressed plates or granules were foamed analogous to “Foaming process” as described above with polymer 5, with its properties as given in Table 3. Granules were obtained by under-water granulation. The granules had a weight of approximately 2 g/100 pellets and a slightly ellipsoidal shape.

TABLE 5
foaming conditions and properties of foamed plates and pellets

| | | | Foaming conditions | | | |
|---|---|---|---|---|---|---|
| Experiment | | Initial | Temperature | Pressure | Soaking time | Properties foam |
| no. | Material | dimensions | (° C.) | (bar) | (min) | Damage: |
| Example 5.6 | Polymer 5 | Granule | 115 | 200 | 15 | No |
| Example 5.7 | Polymer 5 | Granule | 125 | 200 | 15 | No |
| Example 5.8 | Polymer 5 | Granule | 130 | 200 | 15 | No |
| Example 5.9 | Polymer 5 | Granule | 145 | 200 | 15 | Yes - wrinkle/collapse |
| Example 5.10 | Polymer 5 | plate | 115 | 200 | 15 | No |
| Example 5.11 | Polymer 5 | plate | 125 | 200 | 15 | No |
| Example 5.12 | Polymer 5 | plate | 130 | 200 | 15 | No |
| Example 5.13 | Polymer 5 | plate | 145 | 200 | 15 | Yes - wrinkle/collapse |

Examples in Table 5 demonstrate that plate samples and granules exhibited similar foaming windows and allowed for higher foaming temperature before damage was observed. Foamed beads could be obtained from granules combining a low density while not showing any damages up to a foaming temperature of 130° C. Foam beads with density of less than 0.2 g/cm³ could be made.

1. Foam comprising thermoplastic copolyester elastomer in an amount of at least 60 wt % with respect to the total weight of the foam, wherein the thermoplastic copolyester elastomer has a number average molecular weight (Mn) of at least 34000 g/mol and a shore D hardness measured at 3 s of between 28 to 50.

2. Foam according to claim 1, wherein the thermoplastic copolyester elastomer has a Mw/Mn of less than 2.7.

3. Foam according to claim 1, wherein the shore D hardness is between 30 and 45.

4. Foam according to claim 1, wherein the thermoplastic copolyester elastomer comprises hard segments chosen from ethylene terephthalate (PET), propylene terephthalate (PPT), butylene terephthalate (PBT), polybutylene isophthalate (PBI), polyethylene isophthalate (PEI), polyethelyene naphthalate (PEN), polybutylene naphthalate (PBN), and polypropylene naphthalate (PPN) and combinations thereof.

5. Foam according to claim 4, wherein the thermoplastic copolyester elastomer comprises hard segments being PBT optionally in combination with PBI.

6. Foam according to claim 1, wherein the thermoplastic copolyester elastomer comprises soft segments being polytetramethylene oxide (PTMO), polyethylene oxide (PEO), polypropylene oxide (PPO), block copolymers of poly(ethylene oxide) and poly(propylene oxide), linear aliphatic polycarbonates, polybutylene adipate (PB A) and derivates of dimer fatty acids or dimer fatty acid diols, linear aliphatic polyesters and combinations thereof.

7. Foam according to claim 6, wherein the thermoplastic copolyester elastomer comprises soft segments being PEO-PPO-PEO or PTMO.

8. Foam according to claim 1, wherein the foam has a density of between 0.05 to 0.70 g/cm³, preferably between 0.06 to 0.50 g/cm³ and even more preferred between 0.07 and 0.30 g/cm³.

9. Foam according to claim 1, wherein the foam further comprises a plasticizer in an amount of at most 30 wt % with respect to the total weight of the foam, and wherein the plasticizer is chosen from phthalate esters, dibasic acid esters, mellitates and esters thereof, cyclohexanoate esters, citrate esters, phosphate esters, modified vegetable oil esters, benzonate esters, and petroleum oils and combinations thereof.

10. Process for preparing a foam according to claim 1, comprising the following steps:
a) Providing a composition comprising thermoplastic copolyester elastomer in an amount of at least 60 wt % with respect to the total weight of composition, wherein the thermoplastic copolyester elastomer has a number average molecular weight (Mn) of at least 34000 g/mol and a shore D hardness measured at 3 s of between 28 to 50;
b) Bringing the composition to a foaming temperature of between (Tₘ-100) ° C. and Tₘ, in which Tₘ is the melting temperature in ° C. of the thermoplastic copolyester elastomer as measured according to ISO 11357-3:2011 by DSC in the second heating curve, with a heating and cooling rate of 10° C. per min, under nitrogen atmosphere;
c) Providing a physical blowing agent under pressure to the composition;
d) Releasing the pressure thereby forming the foam.

11. Process according to claim 10, wherein the composition in step a) is provided in the form of granules.

12. Process according to claim 10, wherein the obtained foam after step d) is further processed into a shape by
a)embedding foam in a matrix and forming into a desired shape; or
b) treating the foam with steam and subsequently forming into a shape.

13. Article comprising the foam according to claim 1.

14. Article according to claim 11, wherein the article is a part of a shoe, seating, matrass or golf ball.

15. Article according to claim 13, wherein the article is a midsole or a shoe sole.
